(19) United States
(12) Patent Application Publication
(10) Pub. No.: US 2010/0037749 A1
(43) Pub. Date: Feb. 18, 2010

(54) Drum rim system

(76) Inventor: Scott Alan Brunson, Colorado Springs, CO (US)

Correspondence Address: LAW OFFICE OF DALE B. HALLING, 3595 FOUNTAIN BOULEVARD SUITE A2, COLORADO SPRINGS, CO, 80910, US

(21) Appl. No.: 12/322,519

(22) Filed: Feb. 3, 2009

Related U.S. Application Data
(60) Provisional application No. 61/063,501, filed on Feb. 4, 2008.

(51) Int. Cl. G10D 13/02

(52) U.S. Cl. 84/411 R; 84/421

(57) ABSTRACT

The invention is related to a drum rim system that has a drum rim that fits over the drumhead. A tensioning system tensions the drum rim. A ball and socket mechanism is used as a quick connector for the tensioning system. The tensioning system is a drum lug and a tension rod. In one embodiment, the drum lug has a socket, which engages a ball stud that is attached to the drum shell. The tension rods extend through holes in the drum rim and screw into the drum lugs. When tension rods are loosened it is easy to remove drum lugs because of the ball and socket connection. The ball and socket connection can take numerous other forms.

### RELATED APPLICATIONS

The present invention claims priority on provisional patent application, Ser. No. 61/063,501, filed on Feb. 4, 2008, entitled “Acoustical drum lug-2” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Acoustical drums have a shell that is generally cylindrical. A drumhead is stretched over the ends of the shell. A drum rim is connected to tension rods that screw into drum lugs and are used to tune the drumhead. The drum rim is a hoop that fits over the edge of the drumhead and has holes through which the tension rods extend. The drum lugs are attached to the drum shell. By screwing the tension rods into the drum lugs, the drumhead is tightened or loosened which tunes the drumhead. When replacing the drumhead, the tension rods have to be removed from the drum lugs. Trying to get the tension rods to align with the drum lugs can be difficult because of misalignment of the rim holes and the drum lugs. In addition, it takes a good deal of time to remove all the tension rods and then reconnecting them after the drumhead has been replaced.

Another problem drummers face is mounting drums. Today's mounting systems require a suspension arm be attached to the tension rods then a L rod is attached to the bracket attached to the suspension arm. This is time consuming and makes the drum heavier.

Thus, there exists a need for a drum rim system that is easy to use, easy to align and makes it easy for the drum to be mounted.

### BRIEF SUMMARY OF INVENTION

A drum rim system that overcomes these and other problems has a drum rim that fits over the drumhead. A tensioning system tensions the drum rim. A ball and socket mechanism is used as a quick connector for the tensioning system. The tensioning system is a drum lug and a tension rod. In one embodiment, the drum lug has a socket, which engages a ball stud that is attached to the drum shell. The tension rods extend through holes in the drum rim and screw into the drum lugs. When tension rods are loosened it is easy to remove drum lugs because of the ball and socket connection. The ball and socket connection can take numerous other forms. For instance, the socket can be connected to the drum shell and then the heads of the tension rods can form the ball. Alternatively, the socket can be formed on the drum rim and heads of the tension rods can form the ball. The ball and socket connection is both quick connect/disconnect and self aligning, which makes it easy to change drumheads.

In one embodiment, the drum lugs have an orifice that engages the L-rod of a drum mounting system. By making the drum lugs dual use it reduces the weight of the drum and the amount of hardware that has to be mounted to the drums.

### BRIEF DESCRIPTION OF THE SEVERAL VIEWS OF THE DRAWINGS

FIG. 1 is a top left perspective view of a drum in accordance with one embodiment of the invention;

FIG. 2A is a top view of a drum rim in accordance with one embodiment of the invention;

FIG. 2B is a side view of a drum rim in accordance with one embodiment of the invention;

FIG. 3 is a side view of a tension rod in accordance with one embodiment of the invention;

FIG. 4 is a top left perspective view of a drum lug in accordance with one embodiment of the invention;

FIG. 5 is a side view of a ball stud and bolt in accordance with one embodiment of the invention;

FIG. 6 is a top view of a drum rim in accordance with one embodiment of the invention;

FIG. 7 is a side view of a tension rod and drum lug in accordance with one embodiment of the invention;

FIG. 8 is a top right perspective view of a drum lug and L rod in accordance with one embodiment of the invention;

FIG. 9 is a side cutaway view of a tensioning system in accordance with one embodiment of the invention;

FIG. 10 is a side cutaway view of a tensioning system in accordance with one embodiment of the invention;

FIG. 11 is a side view of a tensioning system in accordance with one embodiment of the invention;

FIG. 12 is a top left perspective view of a drum mounting system and drum in accordance with one embodiment of the invention; and

FIG. 13 is a top left perspective view of a drum mounting system and drum in accordance with one embodiment of the invention.

### DETAILED DESCRIPTION OF THE INVENTION

The invention is related to a drum rim system that has a drum rim that fits over the drumhead. A tensioning system tensions the drum rim. A ball and socket mechanism is used at a quick connector for the tensioning system. The tensioning system is a drum lug and a tension rod. In one embodiment, the drum lug has a socket, which engages a ball stud that is attached to the drum shell. The tension rods extend through holes in the drum rim and screw into the drum lugs. When tension rods are loosened it is easy to remove drum lugs because of the ball and socket connection. The ball and socket connection can take numerous other forms. For instance, the socket can be connected to the drum shell and then the heads of the tension rods can form the ball. Alternatively, the socket can be formed on the drum rim and heads of the tension rods can form the ball. The ball and socket connection is both a quick connect/disconnect connection and self aligning connection, which makes it easy to change drumheads.

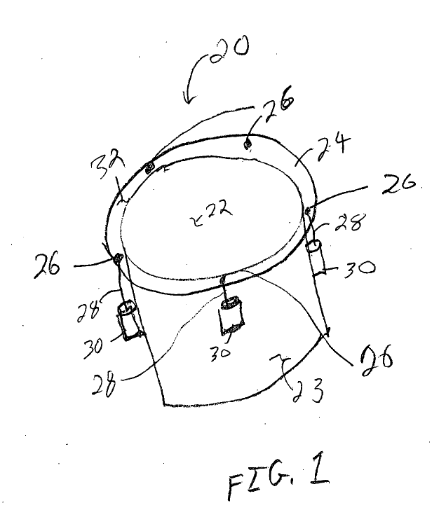

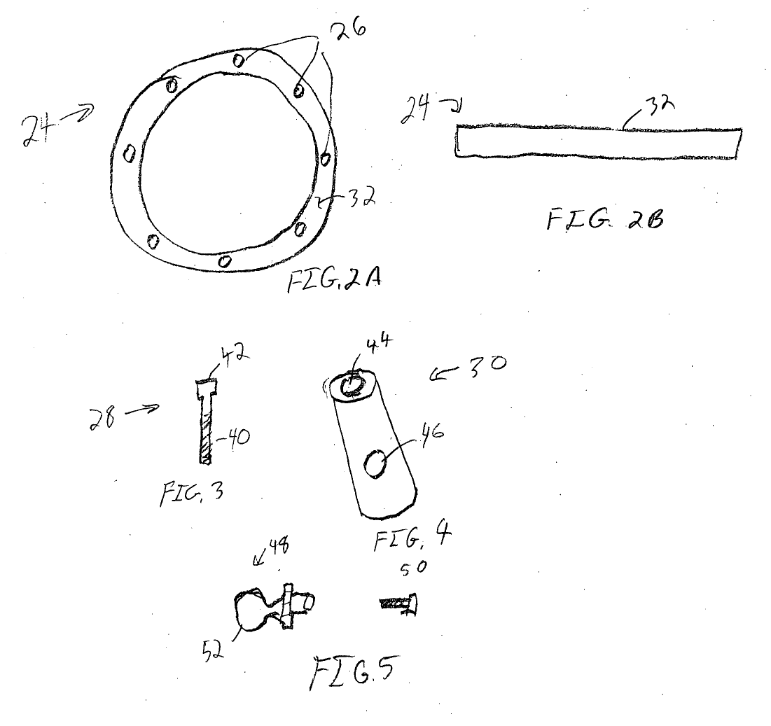

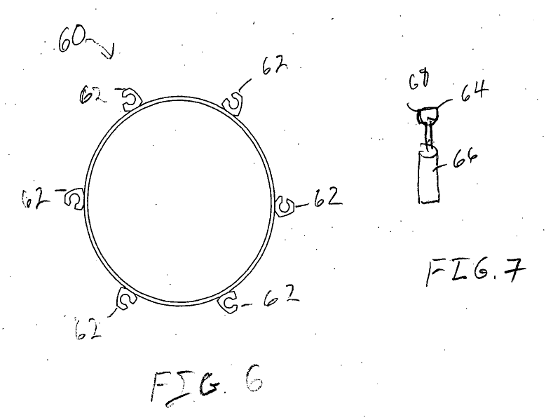

FIG. 1 is a top left perspective view of a drum 20 in accordance with one embodiment of the invention. The drum 20 has a drumhead 22 fits over the drum shell 23 and is held in place with a drum rim 24. The drum rim 24 has a number of holes 26 through which tension rods 28 are inserted. In one embodiment the holes 26 are larger than the stem of the tension rods 28 so that the tension rods are capable of adjusting for slight variations in angle. The tension rods 28 screw into drum lugs 30. The drum lugs 30 are attached to the shell by a quick connect, ball and socket system shown in FIGS. 4-5, 9 & 10. In one embodiment, the drum rim 24 has flat top surface 32 that is at least ½ inch wide. The flat top surface 32 is parallel with the drumhead 22 and essentially flush with the drumhead 22. The drum rim 24 in one embodiment is designed to have a ring or tone when struck with a drumstick. This makes the drum rim 24 an additional musical surface.

FIG. 2A is a top view of a drum rim 24 in accordance with one embodiment of the invention. FIG. 2B is a side view of a drum rim 24 in accordance with one embodiment of the invention. These figures show that the drum rim 24 is essentially a hoop or ring with a flat upper and lower surface.

FIG. 3 is a side view of a tension rod 28 in accordance with one embodiment of the invention. The tension rod 28 is threaded on one end and has a head 42 on the other end.

FIG. 4 is a top left perspective view of a drum lug 30 in accordance with one embodiment of the invention. The drum lug 30 has a threaded opening 44 which engages the tension rod 28. A socket 46 is formed in a side of the drum lug 30.

FIG. 5 is a side view of a ball stud 48 and bolt 50 in accordance with one embodiment of the invention. The bolt 50 is placed on the inside of the drum shell and screwed into the ball stud 48 which is on the outside of the drum shell. The ball stud 48 forms the ball 52 of the ball 52 and socket 46 connector. The ball and socket connector is a quick connect, self aligning connector.

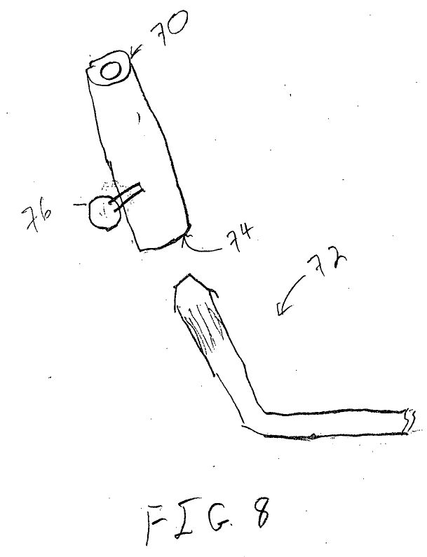

FIG. 6 is a top view of a drum rim 60 in accordance with one embodiment of the invention. The drum rim 60 in this figure has a plurality of socket flanges 62. FIG. 7 is a side view of a tension rod 64 and drum lug 66 in accordance with one embodiment of the invention. The tension rod 64 has a ball shaped head 68 that mates with the socket flange 62 on the drum rim. In this drum rim system the drum lug 66 is mounted to the drum shell in a conventional manner. The tension rods 64 fit through socket flanges 62. In one embodiment, the socket flanges 62 are counter sunk to provide a better self aligning connection. The rim system of FIGS. 6 & 7 is similar to the rim system of FIGS. 1-5 with the ball and socket connection between the rim and the tension rod rather than between a ball socket and the drum lug. Both drum rim systems are quick connect systems and self aligning.

FIG. 8 is a top right perspective view of a drum lug 70 and L rod 72 in accordance with one embodiment of the invention. The drum lug 70 has an opening 74 at one end that mates with the L rod 72 of a mounting system. A knob 76 is used to hold the L rod 72 in position. The drum lug 70 can be similar to that shown in FIG. 4 or 7. This allows the drum lug 70 to be used as part of the mounting system, which reduces the weight of the drum by reducing the amount of hardware that is needed. This mounting system may be used as a rack tom, a floor tom or bass spurs. This mounting system also makes it easier to replace a broken a drumhead since there is not an extra mounting bracket that has to be removed and then reattached. With this system the L rod is removed from drum lug and then the drum lug and tension rod stay with the drum rim. When reattaching the rim, the rim is pressed on the drumhead the drum lugs are snapped onto the ball studs. As a result, the drumhead is already in a pretuned position. The L rod then is just reinserted to an end of a drum lug.

FIG. 9 is a side cutaway view of a tensioning system 80 in accordance with one embodiment of the invention. The tensioning system 80 has a ball stud 82 that is connected to the drum shell 84. A drum lug 86 is shown as a partial cut away to show the socket 88. In this case the socket 88 contains a magnet 90 to pull the ball 82 and socket 88 together. A tension rod 92 is connected to the drum lug 86. The magnet 90 makes the alignment of the ball and socket connection almost automatic.

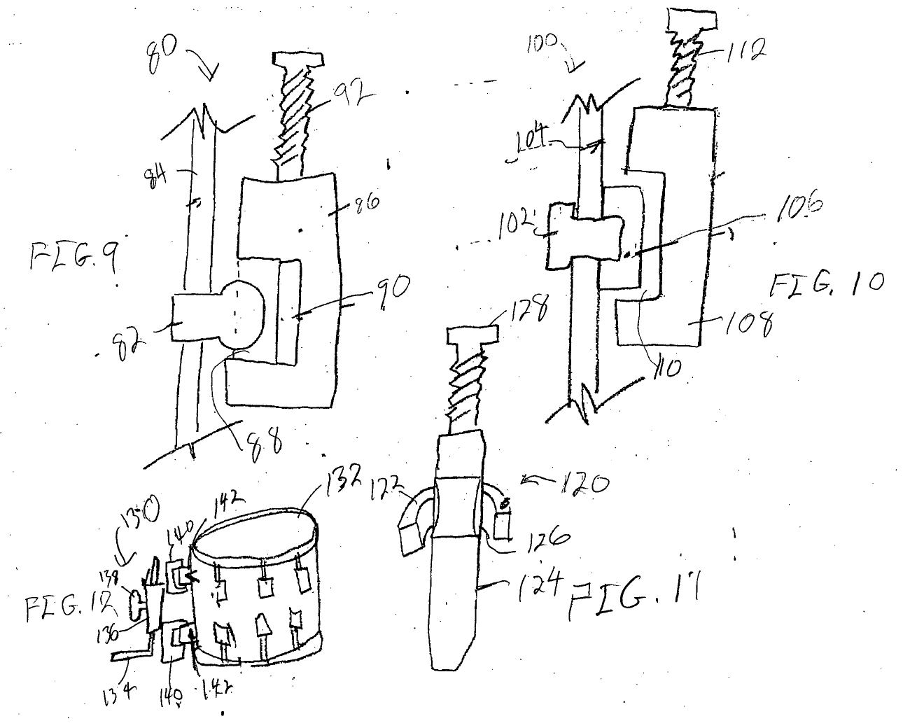

FIG. 10 is a side cutaway view of a tensioning system 100 in accordance with one embodiment of the invention. The tensioning system 100 includes a magnetic stud 102 connected to the drum shell 104 and having a magnet 106 on the outside of the drum shell 104. A drum lug 108 with a socket 110 mates with the magnet stud 106. As used herein this is a ball and socket connection also. A tension rod 112 is attached to the drum lug 108.

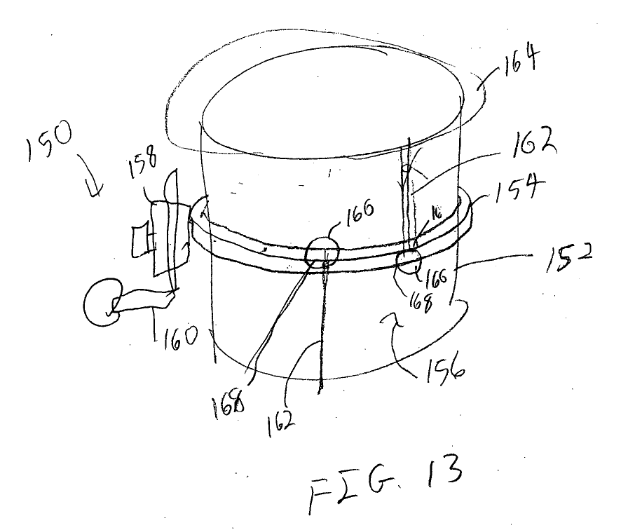

FIG. 11 is a side view of a tensioning system 120 in accordance with one embodiment of the invention. The tensioning system 120 has a socket flange 122 that is bolted on one side to the drum shell. The socket flange 122 has an opening similar to that shown in FIG. 6. A drum lug 124 has a machined area to form a slot 126 that functions like a ball of a ball and socket connection. A tension rod 128 is connected to the drum lug 124.

FIG. 12 is a top left perspective view of a drum mounting system 130 and drum 132 in accordance with one embodiment of the invention. The drum mounting system 130 has a L rod 134 connected to a mounting bracket 136. The mounting bracket 136 has a knob for tighten a bolt against the L rod 134 to hold the L rod 134 in place. The mounting bracket 136 has a pair of C shaped mounting flanges 140 that mate with the drum lugs 142. In one embodiment, the mounting flanges 140 are magnetic. Alternatively the drum lugs 142 are magnetic. Either way the mounting system 130 with the magnets is a quick connect quick release system.

FIG. 13 is a top left perspective view of a drum mounting system 150 and drum 152 in accordance with one embodiment of the invention. The drum mounting system 150 has a drum shell ring 154 which is mounted to the drum shell 156 by bolts. A mounting bracket 158 is bolted to or otherwise attached to the drum shell ring 154. The L rod 160 connects to the mounting bracket 158 in a conventional manner. The a plurality of tensioning rods 162 extend through the drum rim 164 and have a rounded head 166 that mates with a notch 168 that is counter sunk to act like a ball and socket connection. Alternatively, the drum shell rim 154 may have a plurality of socket flanges similar to those shown in FIG. 6.

Thus there has been described a drum rim system that is easy to use, easy to align and makes it easy for the drum to be mounted. As will be apparent to those skilled in the art a number of quick connect/release connections have been illustrated but other combination are possible. All the quick connect, self aligning connectors are based on some sort of slot and flange, which is usually a ball and socket connection. The placement of the ball and socket connection can be moved between the tensioning system and the rim or between the drum shell and the tensioning system. Several quick connect systems are shown for simplifying the mounting system for a drum.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A drum rim system, comprising:
a drum rim that fits over a drumhead;
a tensioning system having a first end and a second end, connecting the drum rim to the drum shell, wherein the tensioning system is used to tune the drumhead; and
a ball and socket connector at a first end of the tension system.

2. The drum rim system of claim 1, wherein the tensioning system includes a drum lug and a tension rod.

3. The drum rim system of claim 2, wherein the ball and socket connector connects the drum rim to the tensioning system.

4. The drum rim system of claim 2, wherein the ball and socket connector connects the drum shell to the tensioning system.

5. The drum rim system of claim 3, wherein the ball of the ball and socket connector is a ball stud attached to the drum shell and the socket is formed in the drum lug.

6. The drum rim system of claim 4, wherein the ball of the ball and socket connector is the head of the tension rod and the socket is a flange attached to the rim.

7. The drum rim system of claim 1, wherein the drum rim is almost flush with the drumhead.

8. The drum rim system of claim 2, wherein the drum lug has a opening to mate with a L-rod.

9. The drum rim system of claim 1, wherein the drum tensioning system includes a tension rod and a drum shell ring.

10. A drum rim system comprising:
a drum rim that fits over a drumhead, the drumhead attached to a drum shell;
a plurality of tensioning mechanisms tensioning the drum rim; and
a ball and socket connector attached to one of the plurality of tensioning mechanisms.

11. The drum rim system of claim 10, wherein the drum rim has a flat surface that is parallel with the drumhead and the flat surface is at least ½ inch wide.

12. The drum rim system of claim 11, wherein the drum rim has a predetermined tone when struck with a drum stick.

13. The drum rim system of claim 10, wherein the tensioning system includes a drum lug and a tension rod.

14. The drum rim system of claim 13, wherein the drum lug has a opening to mate with a L-rod.

15. The drum rim system of claim 14, wherein the drum tensioning system includes a tension rod and a drum shell ring.

16. A drum rim and mounting system, comprising:
a drum rim that fits over a drumhead, wherein the drum rim is essentially flush with the drumhead and has a flat surface that is parallel with the drumhead;
a tensioning system tensioning the drum rim; and
a quick connect mechanism connected to the tensioning system.

17. The drum rim system of claim 16, wherein the quick connect mechanism is a ball and socket connector.

18. The drum rim system of claim 17, wherein the tensioning system includes a drum lug and a tension rod.

19. The drum rim system of claim 18, wherein the drum lug has a opening to mate with a L-rod.

20. The drum rim system of claim 19, wherein the ball and socket connector includes a magnet.
